(19) United States
(12) Patent Application Publication
(10) Pub. No.: US 2026/0017721 A1
(43) Pub. Date: Jan. 15, 2026

(54) ANALYSIS METHOD, APPARATUS, AND DEVICE FOR INVESTMENT DECISION-MAKING, AND STORAGE MEDIUM

(71) Applicant: MIDAS ANALYTICS LIMITED, Hong Kong (HK)

(72) Inventor: Michele De Filippo, Hong Kong (HK)

(21) Appl. No.: 18/768,152

(22) Filed: Jul. 10, 2024

(51) Int. Cl. G06Q 40/06; G06F 40/295; G06F 40/58

(52) U.S. Cl. CPC G06Q 40/06; G06F 40/295; G06F 40/58

(57) ABSTRACT

The present invention provides an analysis method, apparatus, and device for investment decision-making, and a storage medium. The method includes: extracting entities from news data by a custom-trained topic model, and creating a finite state machine to store entities identified from text and relationships between the entities; invoking a custom-trained BERT model to classify the sentiment of the text to generate sentiment types; constructing a graph structure based on the entities and the relationships between the entities, and storing optimized graph structure in a graph database; and in response to a query request from a user being detected, invoking the graph structure associated with the query request and the sentiment type in the graph database for analysis, and generating an analysis result. The present invention solves the problem that the prior art cannot provide analysis data to investors based on intricate financial news.

### TECHNICAL FIELD

The present invention relates to the field of investment analysis, and in particular to an analysis method, apparatus, and device for investment decision-making, and a storage medium.

### BACKGROUND

Financial news is of critical importance to investment in several ways. Serving as the primary channel for investors to obtain information on market dynamics, corporate financial status, and policy changes, financial news enables investors to make informed choices. Additionally, financial news aids investors in forecasting market trends, offering robust support for their investment decisions. Beyond just relaying market dynamics, financial news also helps investors evaluate potential risks. By paying attention to risk warnings and alerts in financial news, investors can identify and respond to potential risks in a timely manner.

In view of the above, this application is hereby filed.

### SUMMARY

The present invention discloses an analysis method, apparatus, and device for investment decision-making, and a storage medium, aiming to solve the problem that the prior art cannot provide analysis data to investors based on intricate financial news.

A first embodiment of the present invention provides an analysis method for investment decision-making, including:
acquiring news data, invoking a custom-trained topic model to extract entities from the news data, and creating a finite state machine to store entities identified from text and relationships between the entities;
invoking a custom-trained BERT model to classify the sentiment of the text to generate sentiment types;
constructing a graph structure based on the entities and the relationships between the entities, optimizing the graph structure, and storing the optimized graph structure in a graph database, where the entities are represented as nodes in the graph structure, and the relationships between the entities are represented as edges in the graph structure; and
in response to a query request from a user being detected, invoking the graph structure associated with the query request and the sentiment type in the graph database for analysis, and generating an analysis result.

Preferably, the analysis result includes detailed information of the graph structure associated with the query request, a risk propagation path of the graph structure associated with the query request, potential correlation of the graph structure associated with the query request, and a future trend of the graph structure associated with the query request.

Preferably, the step of acquiring news data and invoking a custom-trained topic model to extract entities from the news data particularly includes:
tagging text in the news data in an IOB format using a custom-trained LSTM CRF NER model to identify entities in the text, and aggregating extracted individual entity tags to identify multi-tag entities.

Preferably, after acquiring news data and invoking a custom-trained topic model to extract entities from the news data, the method further includes matching the entities with verified finite state machines to create unique identifiers for successfully matched entities.

Preferably, the method further includes:
in response to a new entity being identified, acquiring relevant information of the new entity and comparing the relevant information of the new entity with the entity library to generate comparison information; and
in response to determining, according to the comparison information, that the new entity is an entity previously identified with a different name, associating the new entity with the entity previously identified with the different name; or
in response to determining, according to the comparison information, that the new entity has not been identified before, creating a unique identifier to be associated with the new entity.

Preferably, the step of optimizing the graph structure includes filtering out noise data, merging similar entities, and eliminating duplicate relationships.

Preferably, the sentiment types include positive sentiment, negative sentiment, and neutral sentiment.

A second embodiment of the present invention provides an analysis apparatus for investment decision-making, including:
an entity extraction module, which is configured to acquire news data, invoke a custom-trained topic model to extract entities from the news data, and create a finite state machine to store entities identified from text and relationships between the entities;
a sentiment analysis module, which is configured to invoke a custom-trained BERT model to classify sentiment of the text to generate sentiment types;
a graph structure construction module, which is configured to construct a graph structure based on the entities and the relationships between the entities, optimize the graph structure, and store the optimized graph structure in a graph database, where the entities are represented as nodes in the graph structure, and the relationships between the entities are represented as edges in the graph structure; and
an analysis module, which is configured to, in response to a query request from a user being detected, invoke the graph structure associated with the query request and the sentiment type in the graph database for analysis, and generate an analysis result.

A third embodiment of the present invention provides an analysis device for investment decision-making, including a memory and a processor, where a computer program is stored in the memory, and the computer program is executable by the processor to implement the analysis method for investment decision-making of any one of the above.

A fourth embodiment of the present invention provides a computer-readable storage medium storing a computer program which is executable by a processor of a device in which the computer-readable storage medium is installed to implement the analysis method for investment decision-making of any one of the above.

According to the analysis method, apparatus, and device for investment decision-making, and the storage medium provided by the present invention, by firstly acquiring news data, invoking a custom-trained topic model to extract entities from the news data, and creating a finite state machine to store entities identified from text and relationships between the entities; then, invoking a custom-trained BERT model to classify the sentiment of the text to generate sentiment types; next, constructing a graph structure based on the entities and the relationships between the entities, optimizing the graph structure, and storing the optimized graph structure in a graph database, where the entities are represented as nodes in the graph structure, and the relationships between the entities are represented as edges in the graph structure; and finally, in response to a query request from a user being detected, invoking the graph structure associated with the query request and the sentiment type in the graph database for analysis, and generating an analysis result, the problem that the prior art cannot provide analysis data to investors based on intricate financial news is solved.

### BRIEF DESCRIPTION OF DRAWINGS

FIG. 1 is a flow chart of an analysis device for investment decision-making according to a first embodiment of the present invention;

FIG. 2 is an output example of a Named Entity Recognition (NER) model according to the present invention; and

FIG. 3 is a block diagram of an analysis apparatus for investment decision-making according to a second embodiment of the present invention.

### DETAILED DESCRIPTION

The technical schemes in the embodiments of the present invention are clearly and completely described in the following with reference to the drawings in the embodiments of the present invention. It is obvious that the described embodiments are only some of the embodiments of the present invention and are not all the embodiments thereof. All other embodiments obtained by those of ordinary skill in the art based on the embodiments of the present invention without inventive effort fall within the scope of the present invention.

In order to better understand the technical schemes of the present invention, the embodiments of the present invention are described in detail below with reference to the accompanying drawings.

It should be clear that the described embodiments are only some of the embodiments of the present invention instead of all the embodiments thereof. All other embodiments obtained by those of ordinary skill in the art based on the embodiments of the present invention without inventive effort fall within the scope of protection of the present invention.

Terms used in embodiments of the present invention are for the purpose of describing specific embodiments only and are not intended to limit the present invention. The singular forms “a/an” and “the” as used in the embodiments of the present invention and in the appended claims are also intended to include the plural forms unless the context clearly dictates otherwise.

It should be understood that the term “and/or” used herein is merely an association relationship that describes associated objects, and represents that there may be three kinds of relationships. For example, A and/or B may represent the following three cases: only A exists, both A and B exist, or only B exists. In addition, the slash “/” used herein generally indicates that associated objects are in an “or” relationship.

Depending on the context, the word “if” as used herein may be interpreted as “once”, or “when”, or “in response to determining that”, or “in response to detecting that.” Similarly, depending on the context, the phrases “if it is determined that” or “if it is detected that (a stated condition or event occurs)” can be interpreted as “when it is determined that” or “in response to determining that” or “when it is detected that” or “in response to detecting that (a stated condition or event occurs).”

The reference to “first\second” in the embodiment is merely to distinguish similar objects and does not represent a specific order for the objects, and it is to be understood that “first\second” may be interchanged in a specific order or sequence if allowed. It should be understood that the objects distinguished by “first\second” are interchangeable where appropriate, such that the embodiments described herein can be implemented in an order other than those illustrated or described herein.

Specific embodiments of the present invention are described in detail below with reference to the accompanying drawings.

The present invention discloses an analysis method, apparatus, and device for investment decision-making, and a storage medium, aiming to solve the problem that the prior art cannot provide analysis data to investors based on intricate financial news.

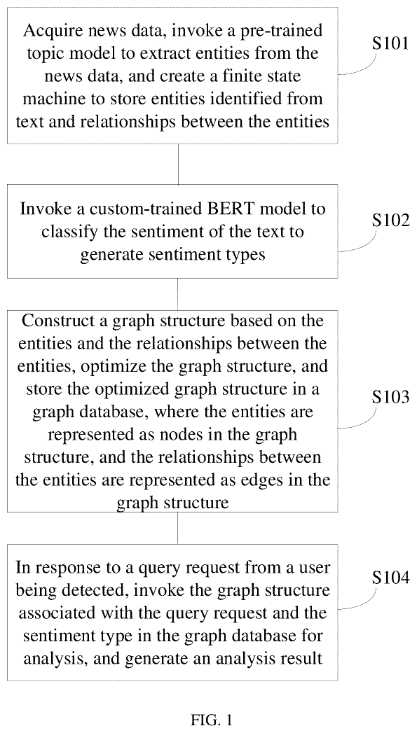

Referring to FIG. 1, a first embodiment of the present invention provides an analysis method for investment decision-making, which can be performed by an analysis device for investment decision-making (hereinafter referred to as analysis device), in particular by one or more processors within the analysis device, to implement at least the following steps.

At S101, news data are acquired, a custom-trained topic model is invoked to extract entities from the news data, and a finite state machine is created to store entities identified from text and relationships between the entities.

In this embodiment, the analysis device can be a notebook computer, a desktop computer, a server, a workstation and other terminal devices with data processing capabilities. The analysis device can be equipped with a corresponding operating system and application software, and the required functions of the embodiment can be realized through the combination of the operating system and the application software.

It should be noted that, in this embodiment, a shuffled random sample based on all articles can be created to train the topic model to ensure that the model is representative of the entire dataset without bias towards any specific source or topic. The model training is performed by the following steps:
a) randomly selecting a sample of articles from the entire dataset by using a random number generator or other random sampling techniques to ensure that the sample is unbiased and representative of the entire dataset; b) pre-processing the sample of articles, which involves cleaning and formatting the text data, such as removing stop words, stemming or lemmatizing, and converting the text to lowercase or other standardized formats; c) using a topic modeling algorithm, such as Latent Dirichlet Allocation (LDA), to train the model on the pre-processed text data, where LDA is a popular algorithm for topic modeling that identifies the underlying topics in a corpus of text data and assigns each document a probability distribution over these topics; d) evaluating the trained model for coherence and interpretability, where coherence measures the degree of semantic similarity between the top words in each topic, while interpretability assesses whether the topics identified by the model are meaningful and coherent; e) improving the performance and interpretability of the model by adjusting the hyperparameters, such as the number of topics or the alpha and beta priors; and f) once the model has been trained and refined, using the model to analyze new articles and identify the underlying topics, and inputting new text data into the model and obtaining the probability distribution over the identified topics.

Further, based on the above approach, two different classes of models can be trained: an article-level model and a sentence-level model. The article-level model is trained to detect the topic of an entire article, while the sentence-level model is trained to detect the topic of an individual sentence. Using the trained models, an arbitrary number of topics can be dynamically detected from the training data. This enables identification of the most relevant and important topics across the entire dataset, without being limited by a pre-determined number of topics. Once the topics are detected, the topics can be fit into a well-defined topic taxonomy. This ensures that the topics are organized in a meaningful and logical way, making it easy for investment decision-makers to understand and retrieve the information.

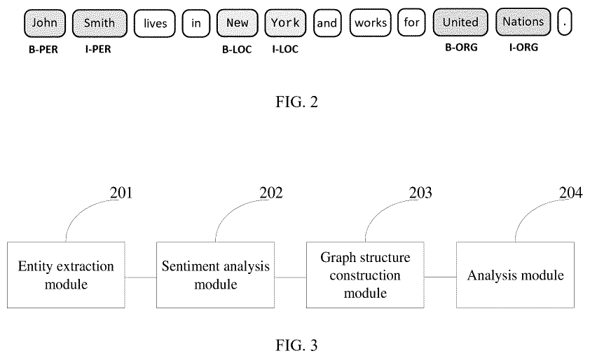

Specifically, in this embodiment, with reference to FIG. 2, an LSTM CRF Named Entity Recognition (NER) model may be utilized to tag text in an IOB format to identify entities within the text. The extracted individual entity tags are aggregated to identify multi-tags entities, ensuring that the full name of the entity is captured. Further, a tree-structured finite state machine (FSM) is created using a preprocessed and verified list of companies and organizations. Each extracted entity is matched against the verified list to ensure that all of the relevant entities mentioned in the article are captured. With the matching and checking, misidentification is filtered out and only accurate entity information is retained. Finally, a unique identifier (UID) is created for each matched organization to enable further analysis and processing. The UIDs not only help distinguish between different entities, but also facilitate tracking and referencing in subsequent analysis.

In a possible embodiment of the present invention, whenever an unidentified entity is encountered, web scraping can be utilized to gather data from various sources, such as entity metadata and related websites. These data are used to compare the unidentified entity with known organizations to determine if the unidentified entity matches any existing entity in our database. If a match is established, the identity of the entity is identified and the entity is linked to its corresponding information in the system. If no known entity is matched, additional information continues to be collected to further refine the understanding of that entity. If the entity has been previously identified with a different name, the existing identifier is assigned to the newly identified entity to ensure consistency in identification of the entity across different sources and articles. This ensures that entities with different names but substantially the same can be processed uniformly. If the entity is not present in the database, a UID is constructed for the newly verified organization. Thus, it is ensured that different entities can be differentiated by their UIDs even if the entities share the same name. This avoids confusion and ensures that each entity is uniquely identified in the system. As more news data are collected, the above process will keep running so that more information is collected about newly discovered entities, hence continually improving the entity disambiguation process. Through dynamic update and adjustment, the system can gradually improve its identification accuracy and processing efficiency.

At S102, a custom-trained BERT model is invoked to classify the sentiment of the text to generate sentiment types.

It should be noted that text data can be preprocessed using natural language processing (NLP) techniques, including identifying named entities, extracting relevant keywords, and removing stop words. This ensures the quality and consistency of the input text, thereby improving the accuracy of subsequent sentiment analysis. The BERT model is used to classify the sentiment of the text as positive, negative, or neutral. The BERT model was trained on a pre-labeled dataset of news articles to ensure accuracy and reliability of classification results. Further, post-processing techniques can be applied to refine the results of the sentiment analysis, such as taking into account negation and intensifiers, and aggregating sentiment scores across multiple sentences or articles. This improves the precision of the sentiment analysis and makes it more in line with the actual sentiment expression.

Further, in this embodiment, news articles in multiple languages are collected and analyzed using multilingual NLP techniques to provide investors with a global perspective. Through NLP techniques, the platform can analyze the sentiments of articles in different languages, so that users can understand the tone of news articles even if they do not speak the language, so as to better grasp market dynamics and trends.

At S103, a graph structure is constructed based on the entities and the relationships between the entities, and the graph structure is optimized, which may include, but is not limited to, filtering out noise data, merging similar entities, and eliminating duplicate relationships; and the optimized graph structure is stored in a graph database, where the entities are represented as nodes in the graph structure, and the relationships between the entities are represented as edges in the graph structure.

It should be noted that, in this embodiment, with the innovative approach of graph neural network (GNN) techniques, deep learning and graph-based representations are leveraged to establish relationships between entities in a structured way. Specifically, a graphical representation model can be built for the preprocessed text data. Herein, each entity and keyword is represented as a node, and the relationships between them are represented as edges, thus forming a complete graph structure. GNNs can be used to learn the structure of graphs, thereby helping to extract relationships and patterns that might not be immediately apparent from a surface-level analysis of the data. GNN takes advantage of the intrinsic features of graphical data, such as the topological structure between nodes and edges and their spatial distribution, significantly improving the accuracy of the model and its ability to identify complex relationships. Of course, the accuracy of the knowledge graph can also be continuously refined and improved through deep learning based on continuous feedback from investors and updates to basic data. The process of continuous improvement ensures that the knowledge graph is always kept up-to-date and most accurate to reflect the latest market dynamics and information.

At S104, in response to a query request from a user being detected, the graph structure associated with the query request and the sentiment type in the graph database are invoked for analysis, and an analysis result is generated.

Herein, the analysis result includes detailed information of the graph structure associated with the query request, a risk propagation path of the graph structure associated with the query request, potential correlation of the graph structure associated with the query request, and a future trend of the graph structure associated with the query request.

It should be noted that the system provides detailed information of the graph structure associated with the query request, which may include involved entities, keywords, topics and their interrelationships. This helps users fully understand the composition of the relevant graph structure and its internal complex relationships. Further, the system can also analyze and display the risk propagation paths in the graph structure associated with the query request. This includes identifying potential sources of risk, the paths of risk transmission, and the potential scope of impact. Still further, the system can also identify and present potential correlations in the graph structure associated with the query request. These correlations may not be immediately obvious from preliminary analysis but can reveal important relationships that are uncovered through deeper exploration of the graph, helping users discover underlying connections and latent opportunities or threats. Still further, the system predicts future trends in graph structures associated with query requests based on existing data and sentiment analysis, including possible development directions, potential drivers of trend changes, and the impact of these changes on the overall graph structures. With these predictions, users can act proactively and make forward-looking decisions.

Referring to FIG. 3, a second embodiment of the present invention provides an analysis apparatus for investment decision-making, including:
an entity extraction module 201, which is configured to acquire news data, invoke a custom-trained topic model to extract entities from the news data, and create a finite state machine to store entities identified from text and relationships between the entities;
a sentiment analysis module 202, which is configured to invoke a custom-trained BERT model to classify the sentiment of the text to generate sentiment types;
a graph structure construction module 203, which is configured to construct a graph structure based on the entities and the relationships between the entities, optimize the graph structure, and store the optimized graph structure in a graph database, where the entities are represented as nodes in the graph structure, and the relationships between the entities are represented as edges in the graph structure; and an analysis module 204, which is configured to, in response to a query request from a user being detected, invoke the graph structure associated with the query request and the sentiment type in the graph database for analysis, and generate an analysis result.

A third embodiment of the present invention provides an analysis device for investment decision-making, including a memory and a processor, where a computer program is stored in the memory, and the computer program is executable by the processor to implement the analysis method for investment decision-making of any one of the above.

A fourth embodiment of the present invention provides a computer-readable storage medium storing a computer program which is executable by a processor of a device in which the computer-readable storage medium is installed to implement the analysis method for investment decision-making of any one of the above.

According to the analysis method, apparatus, and device for investment decision-making, and the storage medium provided by the present invention, by firstly acquiring news data, invoking a custom-trained topic model to extract entities from the news data, and creating a finite state machine to store entities identified from text and relationships between the entities; then, invoking a custom-trained BERT model to classify the sentiment of the text to generate sentiment types; next, constructing a graph structure based on the entities and the relationships between the entities, optimizing the graph structure, and storing the optimized graph structure in a graph database, where the entities are represented as nodes in the graph structure, and the relationships between the entities are represented as edges in the graph structure; and finally, in response to a query request from a user being detected, invoking the graph structure associated with the query request and the sentiment type in the graph database for analysis, and generating an analysis result, the problem that the prior art cannot provide analysis data to investors based on intricate financial news is solved.

For example, the computer program described in the third and fourth embodiments of the present invention may be divided into one or more modules, which are stored in the memory and executed by the processor to implement the present invention. The one or more modules may be a series of computer program instruction segments which can enable specific functions, and the instruction segments are configured to describe the execution process of the computer program in an analysis device for investment decision-making, for example, the apparatus described in the second embodiment of the present invention.

The processor may be a central processing unit (CPU), or other general purpose processors, a digital signal processor (DSP), an application-specific integrated circuit (ASIC), a field-programmable gate array (FPGA), or other programmable logic devices, discrete gates or transistor logic devices, discrete hardware components, etc. The general purpose processor may be a microprocessor, or the processor may be any conventional processor. The processor is a control center of the analysis method for investment decision-making, using various interfaces and circuits to connect various parts that are configured to implement the analysis method for investment decision-making.

The memory may be configured to store the computer programs and/or modules, and the processor can implement various functions of the analysis method for investment decision-making by running or executing the computer programs and/or modules stored in the memory and calling the data stored in the memory. The memory may mainly include a program storage area and a data storage area, where the program storage area may store an operating system and application program(s) required by at least one function (such as an audio playback function and a text conversion function), etc.; and the data storage area can store data (such as audio data and text message data) created from the use of a mobile phone. In addition, the memory may be a high-speed random access memory, or a non-volatile memory, such as a hard disk, internal storage, a plug-in hard disk, a smart media card (SMC), a secure digital (SD) card, a flash card, at least one disk memory device, a flash memory device, or other volatile solid-state memory devices.

Herein, if the implemented modules are implemented in the form of functional units of software and sold or used as independent products, they can be stored in a computer-readable storage medium. Based on this understanding, all or part of the processes of the methods in the above embodiments may also be completed by related hardware with instructions of a computer program which may be stored in a computer-readable storage medium, and the computer program, when executed by a processor, can enable the implementation of the steps of the above methods. Herein, the computer program includes computer program code, which may be in the form of source code, object code, an executable file or in some intermediate forms, etc. The computer-readable medium may include: any entity or device capable of carrying computer program code, a recording medium, a USB flash drive, a removable hard disk, a magnetic disk, an optical disk, a computer memory, a read-only memory (ROM), a random access memory (RAM), an electrical carrier signal, a telecommunication signal, a software distribution medium, etc. It should be noted that the contents contained in the computer-readable medium can be appropriately added or subtracted according to the requirements of legislation and patent practice in jurisdictions. For example, in some jurisdictions, according to legislation and patent practice, the computer-readable medium does not include electrical carrier signals and telecommunication signals.

It should be noted that the apparatus embodiments described above are only for illustration. The units described as separate components may or may not be physically separated, and the components displayed as units may or may not be physical units, that is, they may be located in one place or distributed to multiple network units. Some or all of the modules can be selected according to actual needs to achieve the purpose of the scheme of this embodiment. In addition, in the figures of apparatus embodiments provided by the present invention, the connection between modules means that they are in communication with each other, which can be specifically realized as one or more communication buses or signal wires. Those of ordinary skill in the art can understand and implement it without creative effort.

Only a preferred embodiment of the present invention is described above, and the scope of protection of the present invention is not limited thereto. Any changes or substitutions that can be readily conceived by those skilled in the art within the technical scope disclosed by the present invention shall fall within the scope of protection of the present invention. Therefore, the scope of protection of the present invention should be subject to the scope of protection of the claims.

1. An analysis method for investment decision-making, comprising:
acquiring news data, invoking a custom-trained topic model to extract entities from the news data, and creating a finite state machine to store entities identified from text and relationships between the entities;
invoking a custom-trained BERT model to classify the sentiment of the text to generate sentiment types;
constructing a graph structure based on the entities and the relationships between the entities, optimizing the graph structure, and storing the optimized graph structure in a graph database, wherein the entities are represented as nodes in the graph structure, and the relationships between the entities are represented as edges in the graph structure; and
in response to a query request from a user being detected, invoking the graph structure associated with the query request and the sentiment type in the graph database for analysis, and generating an analysis result.

2. The analysis method for investment decision-making of claim 1, wherein the analysis result comprises: detailed information of the graph structure associated with the query request, a risk propagation path of the graph structure associated with the query request, potential correlation of the graph structure associated with the query request, and a future trend of the graph structure associated with the query request.

3. The analysis method for investment decision-making of claim 1, wherein the step of acquiring news data and invoking a custom-trained topic model to extract entities from the news data particularly comprises:
tagging text in the news data in an IOB format using a custom-trained LSTM CRF NER model to identify entities in the text, and aggregating extracted individual entity tags to identify multi-tag entities.

4. The analysis method for investment decision-making of claim 1, wherein after acquiring news data and invoking a custom-trained topic model to extract entities from the news data, the method further comprises: matching the entities with verified finite state machines to create unique identifiers for successfully matched entities.

5. The analysis method for investment decision-making of claim 3, further comprising:
in response to a new entity being identified, acquiring relevant information of the new entity and comparing the relevant information of the new entity with the entity library to generate comparison information; and
in response to determining, according to the comparison information, that the new entity is an entity previously identified with a different name, associating the new entity with the entity previously identified with the different name; or
in response to determining, according to the comparison information, that the new entity has not been identified before, creating a unique identifier to be associated with the new entity.

6. The analysis method for investment decision-making of claim 1, wherein the step of optimizing the graph structure comprises: filtering out noise data, merging similar entities, and eliminating duplicate relationships.

7. The analysis method for investment decision-making of claim 1, wherein the sentiment types comprise positive sentiment, negative sentiment, and neutral sentiment.

8. An analysis apparatus for investment decision-making, comprising:
an entity extraction module, which is configured to acquire news data, invoke a custom-trained topic model to extract entities from the news data, and create a finite state machine to store entities identified from text and relationships between the entities;
a sentiment analysis module, which is configured to invoke a custom-trained BERT model to classify the sentiment of the text to generate sentiment types;
a graph structure construction module, which is configured to construct a graph structure based on the entities and the relationships between the entities, optimize the graph structure, and store the optimized graph structure in a graph database, wherein the entities are represented as nodes in the graph structure, and the relationships between the entities are represented as edges in the graph structure; and
an analysis module, which is configured to, in response to a query request from a user being detected, invoke the graph structure associated with the query request and the sentiment type in the graph database for analysis, and generate an analysis result.

9. An analysis device for investment decision-making, comprising a memory and a processor, wherein a computer program is stored in the memory, and the computer program is executable by the processor to implement the analysis method for investment decision-making of claim 1.

10. A computer-readable storage medium storing a computer program which is executable by a processor of a device in which the computer-readable storage medium is installed to implement the analysis method for investment decision-making of claim 1.
